(19) United States
(12) Patent Application Publication
(10) Pub. No.: US 2025/0381888 A1
(43) Pub. Date: Dec. 18, 2025

(54) POWER SINK CONTROL SYSTEM FOR A VEHICLE

(71) Applicant: GM Global Technology Operations LLC, Detroit, MI (US)

(72) Inventors: Biju Edamana, Christiansburg, VA (US); Sergio Eduardo Garcia, Commerce Township, MI (US); Joseph Berg, Highland, MI (US); Chad Dubois, Oxford, MI (US); Peter Westra, North Yarmouth, ME (US)

(73) Assignee: GM Global Technology Operations LLC, Detroit, MI (US)

(21) Appl. No.: 18/742,988

(22) Filed: Jun. 13, 2024

(51) Int. Cl. B60L 58/40; B60L 58/12; B60L 58/30; H01M 8/04746; H01M 8/04992

(52) U.S. Cl. CPC B60L 58/40; B60L 58/12; B60L 58/30; H01M 8/04753; H01M 8/04992; H01M 2250/20

(57) ABSTRACT

A control system for a vehicle includes data processing hardware and memory hardware in communication with the data processing hardware. The memory hardware stores instructions that when executed on the data processing hardware cause the data processing hardware to perform operations. The operations include receiving, at a propulsion controller, power generation, comparing, via the propulsion controller, battery data with a state of charge threshold, and executing, based on the comparison of the battery data, a power sink protocol including at least one mode control via a fuel cell system. The operations also include generating, based on the at least one mode control, at least one of a compressor command and a valve command via an airflow system and regulating, via the at least one generated compressor command and the valve command, an airflow of the airflow system.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a control system for a vehicle and more specifically a power sink control system for a vehicle.

Vehicles, in particular electric vehicles, may be equipped with regenerative braking. Regenerative braking provides the vehicle with the ability to harvest battery power during a braking procedure, such that the battery of the vehicle may be recharged under braking. In some instances, the power harvested by regenerative braking exceeds the need for battery recharging. As a result, there is a power surplus. Thus, there is a need for an integrated method by which the excess power may be sunk to minimize strain on the battery, fuel cells, and brakes of the vehicle.

### SUMMARY

In some examples, a computer-implemented method when executed by data processing hardware causes the data processing hardware to perform operations. The operations include receiving, at a propulsion controller, power generation, comparing, via the propulsion controller, battery data with a state of charge threshold, and executing, based on the comparison of the battery data, a power sink protocol including at least one mode control via a fuel cell system. The operations also include generating, based on the at least one mode control, at least one of a compressor command and a valve command via an airflow system and regulating, via the at least one generated compressor command and the valve command, an airflow of the airflow system.

In some instances, comparing the battery data with the state of charge threshold may include determining a state of charge of the battery data exceeds the state of charge threshold. Execution of the power sink protocol may include executing a standby mode of the at least one mode control in response to the state of charge exceeding the state of charge threshold. Optionally, executing the standby mode may include executing power management of a fuel cell of the fuel cell system. In some examples, regulating the airflow may include executing the valve command including closing at least one valve to the fuel cell. The at least one valve may be between a compressor of the airflow system and the fuel cell. In other examples, regulating the airflow may include executing the compressor command including sinking power on a compressor of the airflow system. In further configurations, executing the power sink protocol may include executing a run mode of the at least one mode control. Execution of the run mode may include regulating the airflow from a compressor of the airflow system via at least one of an isolation valve and a bypass valve.

In other aspects, a control system for a vehicle includes data processing hardware and memory hardware in communication with the data processing hardware. The memory hardware stores instructions that when executed on the data processing hardware cause the data processing hardware to perform operations. The operations include receiving, at a propulsion controller, power generation, comparing, via the propulsion controller, battery data with a state of charge threshold, and executing, based on the comparison of the battery data, a power sink protocol including at least one mode control via a fuel cell system. The operations also include generating, based on the at least one mode control, at least one of a compressor command and a valve command via an airflow system and regulating, via the at least one generated compressor command and the valve command, an airflow of the airflow system.

In some examples, comparing the battery data with the state of charge threshold may include determining a state of charge of the battery data exceeds the state of charge threshold. Execution of the power sink protocol may include executing a standby mode of the at least one mode control in response to the state of charge exceeding the state of charge threshold. Optionally, executing the standby mode may include executing power management of a fuel cell of the fuel cell system. In some instances, regulating the airflow may include executing the valve command including closing at least one valve to the fuel cell, the at least one valve between a compressor of the airflow system and the fuel cell. In further instances, regulating the airflow may include executing the compressor command including sinking power on a compressor of the airflow system. Optionally, executing the power sink protocol may include executing a run mode of the at least one mode control. Execution of the run mode may include regulating the airflow from a compressor of the airflow system via at least one of an isolation valve and a bypass valve.

In further aspects, a control system for a vehicle includes data processing hardware and memory hardware in communication with the data processing hardware. The memory hardware stores instructions that when executed on the data processing hardware cause the data processing hardware to perform operations. The operations include receiving, at a propulsion controller, power generation, comparing, via the propulsion controller, battery data with a state of charge threshold, and executing, based on the comparison of the battery data, a power sink protocol including at least one mode control via a fuel cell system. The at least one mode control includes a standby mode and a run mode. The operations also include selecting, via a fuel cell controller, one of the standby mode and the run mode, generating, based on the selected at least one mode control, at least one of a compressor command and a valve command via an airflow system, and regulating, via the at least one generated compressor command and the valve command, an airflow of the airflow system. The operations further include monitoring, at the fuel cell system, fuel cell data and adapting, based on the monitored fuel cell data, the power sink protocol including the selected mode control.

The operations may also include executing, at the fuel cell system, fuel cell diagnostics. Optionally, executing the power sink protocol may include executing a standby mode of the at least one mode control in response to the state of charge exceeding the state of charge threshold and executing power management of a fuel cell of the fuel cell system. In some instances, executing the power sink protocol may include executing a run mode of the at least one mode control and regulating the airflow from a compressor of the airflow system via an isolation valve.

### BRIEF DESCRIPTION OF THE DRAWINGS

The drawings described herein are for illustrative purposes only of selected configurations and are not intended to limit the scope of the present disclosure.

FIG. 1 is a schematic of a power sink control system according to the present disclosure;

FIG. 2 is an exemplary block diagram of a power sink control system according to the present disclosure;

FIG. 3 is another exemplary block diagram of a power sink control system according to the present disclosure;

FIG. 4 is a schematic of a standby mode of a power sink control system according to the present disclosure;

FIG. 5 is a schematic of a run mode of a power sink control system according to the present disclosure;

FIG. 6 is an exemplary flow diagram of a power sink control system according to the present disclosure; and

FIG. 7 is a continued flow diagram for the power sink control system of FIG. 6.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

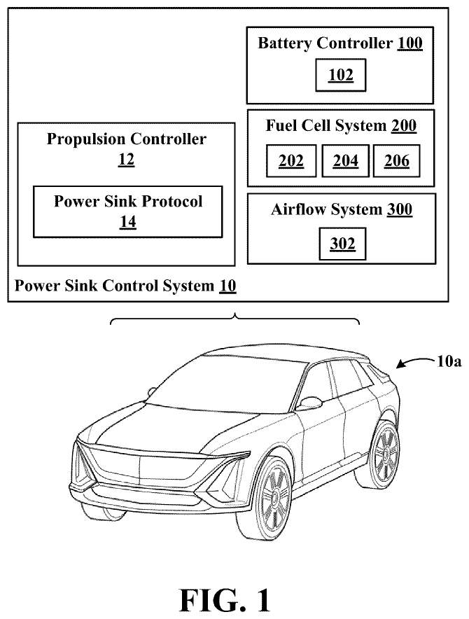

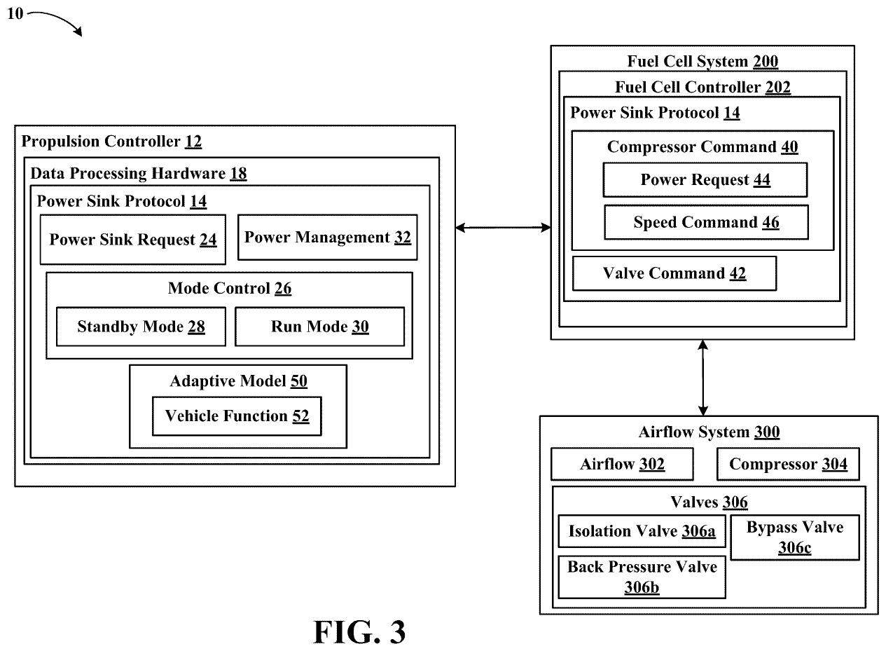

Referring to FIGS. 1-3, a power sink control system 10 for a vehicle 10a includes a propulsion controller 12 configured to execute a power sink protocol 14. The propulsion controller 12 is communicatively coupled with a battery controller 100, a fuel cell system 200, and an airflow system 300 of the vehicle 10a. The propulsion controller 12 communicates with each of the battery controller 100, the fuel cell system 200, and the airflow system 300 when executing the power sink protocol 14 and when determining whether to execute the power sink protocol 14. The power sink control system 10 advantageously provides the vehicle 10a with an integrated control system 10 configured to sink power to the fuel cell system 200 while utilizing the airflow system 300 to consume the power sunk to the fuel cell system 200, as described below. For example, the fuel cell system 200 may be coupled with a fuel injector 120 via an ejector 122 to receive fuel. The airflow system 300 delivers airflow 302 into the fuel cell system 200 to utilize the fuel from the fuel injector 120 and generate power. The power sink protocol 14 is configured to redirect the airflow 302 within the fuel cell system 200 to sink power and minimize power generation by the fuel cell system 200.

In some examples, the vehicle 10a may be configured as an electric vehicle (EV) and/or as a hybrid vehicle, such that the battery controller 100 is configured to monitor battery data 102 corresponding to one or more batteries 104 of the vehicle 10a. The battery data 102 may include a state of charge 106 of each battery 104, which may be communicated with the propulsion controller 12. For example, the propulsion controller 12 may monitor the state of charge 106 of the battery 104 through communication with the battery controller 100. In some instances, the propulsion controller 12 may request the battery data 102 in response to power generation 16 identified by the propulsion controller 12. In other instances, the battery controller 100 may be configured to regularly provide the battery data 102 at intervals to the propulsion controller 12. The propulsion controller 12 may also be configured to estimate the state of charge 106.

The propulsion controller 12 includes data processing hardware 18 that is configured to execute the power sink protocol 14. The data processing hardware 18 is in communication with memory hardware 20 that stores instructions, corresponding to the power sink protocol 14, that, when executed on the data processing hardware 18, cause the data processing hardware to perform operations, described herein. The memory hardware 20 may store a state of charge threshold 22, which may be utilized by the propulsion controller 12 when evaluating the battery data 102. For example, the propulsion controller 12 may receive and/or identify the power generation 16 and, in response, may evaluate the battery data 102. The battery data 102 may include the state of charge 106 of the battery 104. The state of charge 106 may be an estimation or precise measure at the battery 104.

The propulsion controller 12 may compare the state of charge 106 with the state of charge threshold 22 stored on the memory hardware 20 to determine whether to issue a power sink request 24 to the fuel cell system 200. If the state of charge 106 of the battery 104 is below the state of charge threshold 22, then the propulsion controller 12 may refrain from issuing the power sink request 24, as the battery 104 is operating at a reduced power. Additionally or alternatively, the propulsion controller 12 may issue the power sink request 24 corresponding to a mode control 26 that selectively sinks power in an adaptive configuration, described below. Thus, the propulsion controller 12 would want to minimize additional power sinking of the battery 104 based on the state of charge 106. If the state of charge 106 is less than the state of charge threshold 22, then the power sink control system 10 may determine that the power generation 16 is suitable for execution at the fuel cell system 200 without executing the power sink protocol 14. However, the power sink protocol 14 may continue to monitor the state of charge 106 of the battery 104 via the propulsion controller 12, which may issue additional power sink requests 24 during operation of the vehicle 10a.

With further reference to FIGS. 1-3, it is contemplated that the vehicle 10a may have multiple batteries 104 and that some batteries 104 may have a state of charge 106 greater than the state of charge threshold 22 and other batteries 104 may have a state of charge 106 less than the state of charge threshold 22. In those instances, the propulsion controller 12 may identify the batteries 104 with a state of charge 106 exceeding the state of charge threshold 22 and proceed with issuing the power sink request 24 based on the corresponding batteries 104. Thus, the fuel cell system 200 may partially execute the power sink protocol 14 based on the various states of charge 106 of the batteries 104 within the vehicle 10a. In some instances, the fuel cell system 200 may be configured with the power sink protocol 14, such that the power sink protocol 14 may be executed by both the propulsion controller 12 and the fuel cell controller 202. For example, a first portion of the power sink protocol 14 may be executed at the propulsion controller 12 and a second portion of the power sink protocol 14 may be executed at the fuel cell controller 202. In some instances, the state of charge threshold 22 may be adjusted or programmed to correspond to a state of charge 106 and/or may be adjusted or programmed based on a charge rate of the battery 104. Upon executing the comparison, the propulsion controller 12 may determine that the state of charge 106 exceeds the state of charge threshold 22 and may issue, in response, the power sink request 24.

The power sink request 24 is provided to the fuel cell controller 202 of the fuel cell system 200, and the fuel cell controller 202 monitors respective fuel cells 204 of the vehicle 10a. The fuel cell controller 202 gathers fuel cell data 206, which may be communicated with the propulsion controller 12 in response to the power sink request 24, which may be analyzed as part of the power sink protocol 14. The power sink request 24 may be issued as part of the power sink protocol 14 and may include at least one mode control 26, which is executed by the fuel cell controller 202. For example, the mode control 26 includes a standby mode 28 and a run mode 30.

The standby mode 28 is generally associated with a power sink function 34 executed by the fuel cell controller 202. For example, the fuel cell controller 202 executes the power sink function 34 when executing the power sink protocol 14. Each of the standby mode 28 and the run mode 30 may be associated with power management 32 of the power sink protocol 14. The power management 32 of the power sink protocol 14 and the mode controls 26 may be executed simultaneously or independently of each other. The power management 32 is configured to utilize, in part, the power generation 16 received at the propulsion controller 12 in combination with the power sink protocol 14 to maximize an efficiency of the fuel cell system 200. The fuel cell controller 202 may adjust a power level 36 of the fuel cell 204 based on the power sink protocol 14 as part of the power management 32.

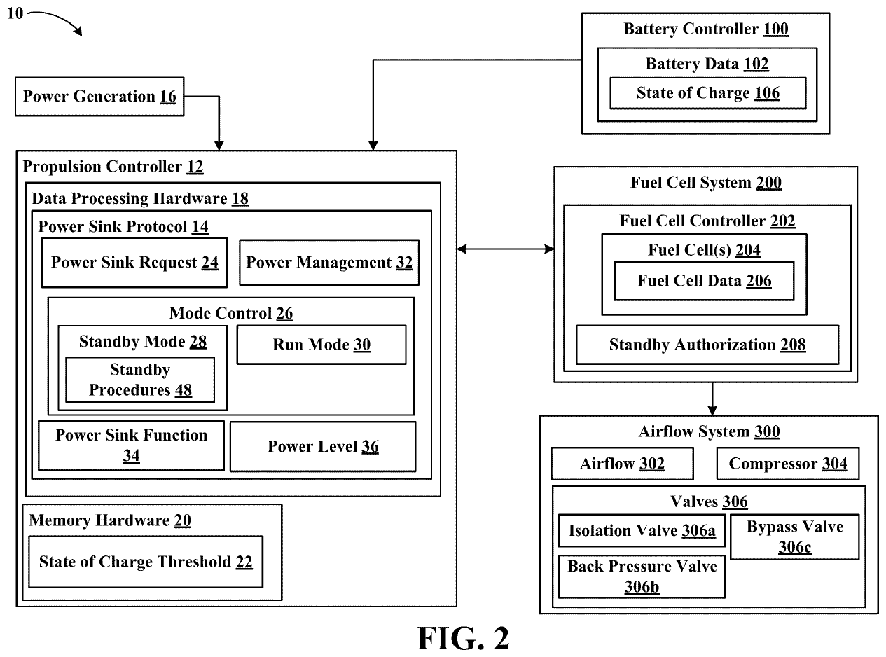

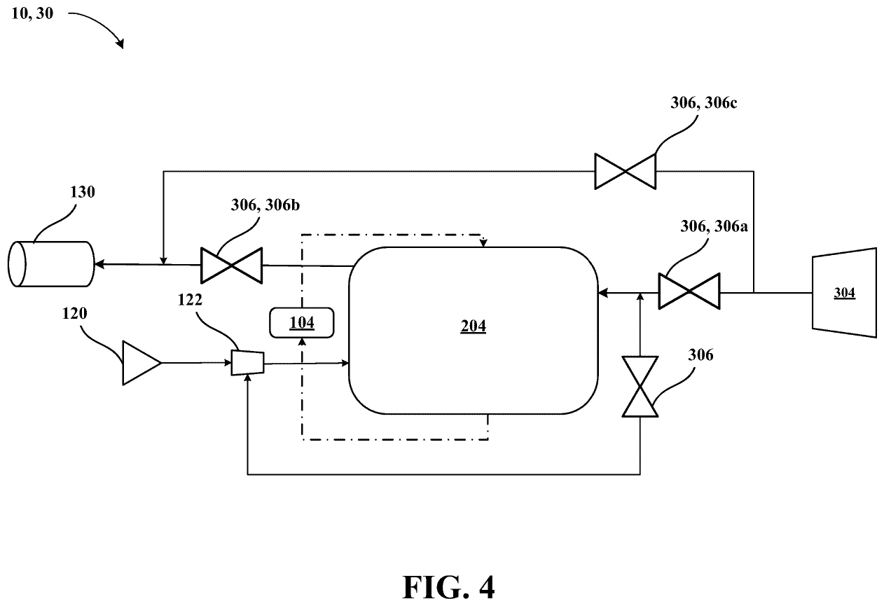

Referring to FIGS. 2-4, the standby mode 28 may have greater efficiencies as compared to the run mode 30, as the power management 32 associated with the respective fuel cell 204 may be increased. For example, the fuel cells 204 may have reduced power when the standby mode 28 is executed as a result of the power management 32 executed as part of the power sink protocol 14. The run mode 30 generally corresponds to a primary mode of the fuel cells 204, while also executing the power management 32. It is contemplated that the power management 32 operation of the power sink protocol 14 may be less in the run mode 30 as compared to the standby mode 28. However, in either mode 28, 30 the fuel cell system 200 is managing the power at the fuel cells 204.

The fuel cell controller 202 is configured to identify whether the standby mode 28 of the power sink protocol 14 is allowed and whether to activate the power sink function 34. For example, the standby mode 28 may be authorized by the fuel cell controller 202, and the fuel cell controller 202 may communicate a standby authorization 208 with the propulsion controller 12. Regardless of whether the standby mode 28 or the run mode 30 is executed, the fuel cell system 200 communicates with propulsion controller 12. The fuel cell controller 202 is configured to communicate with the airflow system 300 regardless of the mode control 26, such that the airflow 302 may be monitored and adjusted relative to the fuel cell 204 in both modes 28, 30.

The airflow system 300 includes a compressor 304 and valves 306 that are configured to direct the airflow 302 from the compressor 304. For example, the airflow 302, under normal operations, may be directed from the compressor 304 toward the fuel cell system 200 and is mixed at the fuel cell 204 with the fuel received from the fuel injector 120. The valves 306 are configured to redirect the airflow 302 from the compressor 304 in response to the power sink protocol 14. The power sink protocol 14 may also be executed at the fuel cell controller 202, such that the fuel cell controller 202 may execute a compressor command 40 and a valve command 42 of the power sink protocol 14. The compressor command 40 and the valve command 42 are configured to adjust settings of the compressor 304 and the valves 306 depending on the executed mode control 26. For example, the compressor command 40 may include a compressor power request 44 and a speed command 46, which may affect the airflow 302 from the compressor 304.

The power and speed of the compressor 304 may be adjusted in response to the compressor command 40 in that power of the compressor 304 may be increased by increasing the speed or pressure ratio across the compressor 304 during the power sink function 34. The adjustment in response to the compressor command 40 may sink or otherwise utilize the power generation 16 at the compressor 304 rather than the fuel cell 204. The compressor 304 may continue to generate the airflow 302, and the airflow 302 may be redirected in response to the valve command 42. For example, the valve command 42 may be configured to open and close valves 306 of the airflow system 300 to redirect the airflow 302 relative to the fuel cell system 200.

In the standby mode 28, the fuel cell system 200 may execute the compressor command 40 and the valve command 42 to redirect the airflow 302 while also sinking the power at the compressor 304. The standby mode 28 may also include standby procedures 48 that may be executed by the fuel cell controller 202 as part of the power sink protocol 14. For example, the standby procedures 48 may include, but are not limited to, sealing a stack of the fuel cells 204 and reducing a voltage of the fuel cells 204. The power sink protocol 14 may execute the compressor command 40 and the valve command 42 to sink power on the compressor 304 to match the power sink request 24. As generally referenced above, the process of sinking power is configured to redistribute power at the compressor 304 rather than at the fuel cell system 200.

In some examples, the airflow system 300 may close at least one valve 306 in response to the valve command 42. For example, the airflow system 300 may close an isolation valve 306a that controls the airflow 302 toward the fuel cell 204, such that the closed valve 306 is located between the compressor 304 and the fuel cell 204. In some instances, the airflow system 300 may control a back pressure valve 306b located between a tailpipe 130 of the vehicle 10a and the fuel cell 204. The closed valves 306a, 306b prevent the airflow 302 from accessing the fuel cell 204 and, thus, the power may be entirely consumed by the compressor 304 during the standby mode 28.

The closure of both the isolation valve 306a and the back pressure valve 306b redirects the airflow 302 away from the fuel cell 204. The power sink protocol 14 executes the valve command 42 during the standby mode 28 to maximize the power consumed by the compressor 304 in response to the power sink request 24. The power consumed by the compressor 304 may be translated by an increased volume of airflow 302 being expelled by the compressor 304. The additional airflow 302 bypasses the fuel cell 204 as a result of the closed valves 306a, 306b. The restriction of airflow 302 to the fuel cell 204 results in arresting power generation by the fuel cell 204. Thus, the power sink protocol 14, by regulating the airflow 302, sinks the potential of power generation at the compressor 304.

Referring now to FIGS. 2, 3, and 5, in some instances, the fuel cell system 200 may detect that the standby mode 28 is unavailable and the propulsion controller 12 may execute the run mode 30 of the power sink protocol 14. The run mode 30 may generally correspond to the standard operation of the fuel cell system 200, except that the fuel cell system 200 is able to selectively control the airflow 302 within the fuel cell system 200 by manipulating the valves 306 to control the airflow 302 from the compressor 304. For example, the fuel cell controller 202 may spool the compressor 304 and coordinate the valves 306 of the airflow system 300 to maintain stable operation of the fuel cell 204 at minimum power. During the run mode 30, the compressor 304 is increased to at least partially consume power, and the valves 306 are managed to prevent a surge of the compressor 304.

The run mode 30 may also be referred to as a power generation mode, as power may be generated as a result of operation of the vehicle 10a, as described below. During the run mode 30, the fuel cell controller 202 controls the airflow 302 passing through the isolation valve 306a to minimize the airflow 302 at the fuel cell 204. The isolation valve 306a, as mentioned above, is positioned between the compressor 304 and the fuel cell 204 and may selectively be closed to redirect the airflow 302 away from the fuel cell 204. When the airflow 302 is redirected, the airflow 302 may pass through a bypass valve 306c between the isolation valve 306a and the tailpipe 130. Thus, the valves 306 include, but are not limited to, the isolation valve 306a, the back pressure valve 306b, and the bypass valve 306c. It is contemplated that the airflow system 300 may include additional valves 306 that may be used to navigate the airflow 302 within the fuel cell system 200. In the run mode 30, the compressor 304 may direct airflow 302 toward the fuel cell 204 via the isolation valve 306a. The compressor 304 may also consume excess power that may be generated as a result of braking by the vehicle 10a.

For example, the vehicle 10a may be configured to execute regenerative braking during which power may be generated by the fuel cell system 200. In the event that an extended duration of braking occurs, the power sink protocol 14 is executed by the propulsion controller 12. Depending on the power assessment of the fuel cell system 200, the fuel cell system 200 may deny the power sink request 24, which may include the request to execute the standby mode 28. The power sink protocol 14 may, instead, execute the run mode 30 during which the compressor 304 may consume, or sink, some power while the fuel cell system 200 generates power at a minimal rate. The run mode 30 may be executed as a result of an intermediary of braking and non-braking, such that some power generation may occur at the fuel cell 204, while power sinking may also be advantageous under certain conditions.

The power generation by the fuel cell system 200 is controlled via the regulation of the airflow 302 passing through the fuel cell(s) 204. Thus, the run mode 30 of the power sink protocol 14 may be executed as an integrated monitor at the fuel cell system 200 to coordinate each of the isolation valve 306a, the back pressure valve 306b, and the bypass valve 306c to maintain stable operation of the fuel cell system 200. The stable operation of the fuel cell system 200 is designed to be maintained at a minimum power load while executing the run mode 30.

In some instances, the power sink protocol 14 may include executing an adaptive model 50. The adaptive model 50 is configured to adapt the standby mode 28 to user behavior or vehicle configurations that may be implemented as a fuel saving technique. For example, the adaptive model 50 may selectively execute the standby mode 28 based on the fuel cell data 206 and/or a vehicle function 52. An exemplary vehicle function 52 may include, but is not limited to, a start-stop function where the fuel cell system 200 may be placed in a temporary standby mode 28 by the adaptive model 50 and then subsequently transitioned into the run mode 30. The adaptive model 50 is configured to minimize wear at electrodes of the fuel cells 204 and thus extend the useful life of the fuel cell system 200. Thus, the adaptive model 50 advantageously balances the standby mode 28 and the run mode 30 to both maximize the useful life of the fuel cell system 200 while capitalizing efficiency of the fuel cell system 200 based on user interaction.

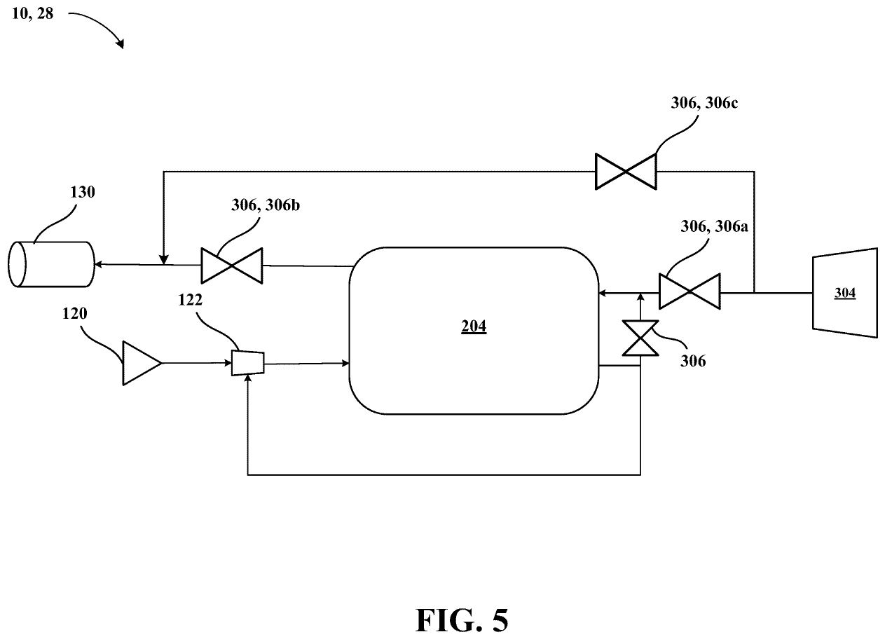

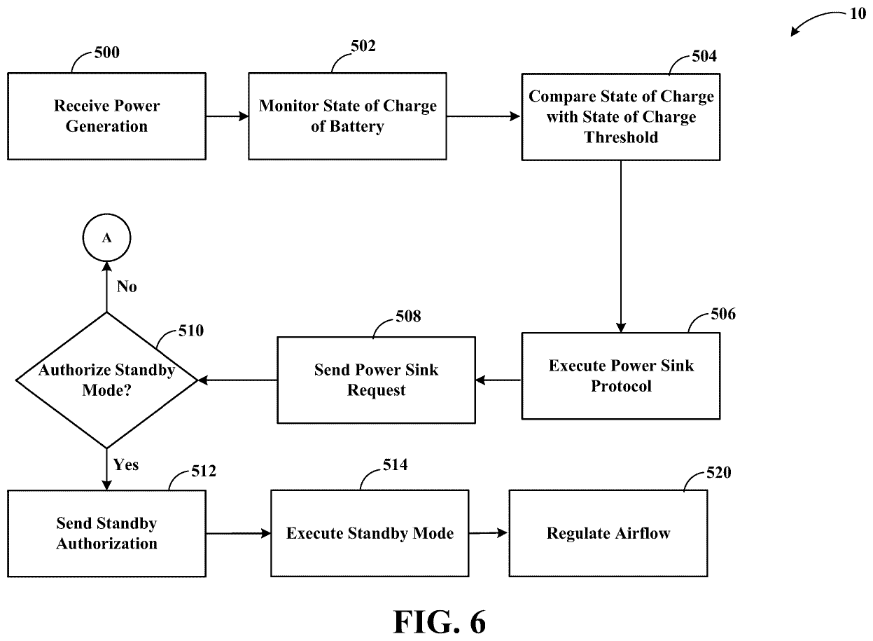

Referring again to FIGS. 5 and 6, an exemplary flow diagram of the power sink control system 10 is illustrated. At 500, the propulsion controller 12 receives and/or identifies power generation 16 and monitors, at 502, the state of charge 106 of the battery 104. The propulsion controller 12 compares, at 504, the state of charge 106 of the battery 104 with the state of charge threshold 22 and executes, at 506, the power sink protocol 14. The power sink protocol 14 sends, at 508, the power sink request 24 to the fuel cell system 200, and the fuel cell system 200, at 510, determines whether to authorize the standby mode 28.

If the fuel cell system 200 determines to authorize the standby mode 28, the fuel cell system 200, at 512, sends a standby authorization 208 to the propulsion controller 12, and the propulsion controller 12 executes, at 514, the standby mode 28. If the fuel cell system 200 determines not to authorize the standby mode 28, then the propulsion controller 12, at 516, executes the run mode 30. During the determination of the mode control 26, the power sink protocol 14 executes, at 516, power management 32 at the fuel cell(s) 204. The selected modes 28, 30 and the power management 32 are communicated with the airflow system 300 as part of the power sink protocol 14.

The airflow system 300 receives a compressor command 40 and/or a valve command 42 and executes, at 518, the respective commands 40, 42. As a result, the compressor 304 consumes the power requested to reduce and/or control the power generation by the vehicle 10a. If the standby mode 28 is executed, then the valve command 42 may include regulating, at 520, the airflow 302 to the isolation valve 306a and the back pressure valve 306b to cut-off the airflow 302 to the fuel cell 204. If the run mode 30 is executed, then the valve command 42 may include regulating, at 522, the airflow 302 by selectively altering the valves 306 to maintain minimum power at the fuel cell 204. In either execution, the power of the compressor 304 is increased to consume the power by increasing the speed or pressure ratio across the compressor 304.

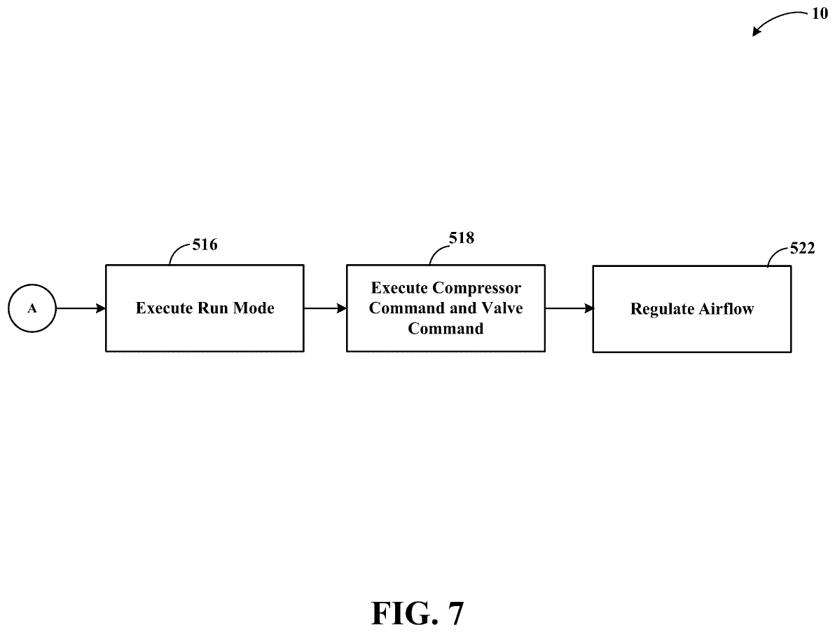

Referring again to FIGS. 1-7, the power sink control system 10 advantageously integrates the power sink protocol 14 with a fuel cell system 200 and an airflow system 300 via the propulsion controller 12. The integration of the power sink protocol 14 advantageously sinks power to the fuel cell 204 to reduce the use of regenerative braking when a state of charge 106 of the battery 104 is full or greater than the state of charge threshold 22. Thus, the power sink control system 10 may quickly sink the power at the compressor 304 as a result of the power sink protocol 14, described above, while maintaining the fuel cell system 200 at a minimum power level. In some instances described above, the fuel cell controller 202 may execute the power sink function 34, associated with the standby mode 28, when executing the power sink protocol 14. Further, the adaptive model 50 of the power sink protocol 14 advantageously provides the ability to switch between mode controls 26 depending on a vehicle function 52.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, at a propulsion controller, power generation;
comparing, via the propulsion controller, battery data with a state of charge threshold;
executing, based on the comparison of the battery data, a power sink protocol including at least one mode control via a fuel cell system;
generating, based on the at least one mode control, at least one of a compressor command and a valve command via an airflow system; and
regulating, via the at least one generated compressor command and the valve command, an airflow of the airflow system.

2. The method of claim 1, wherein comparing the battery data with the state of charge threshold includes determining a state of charge of the battery data exceeds the state of charge threshold.

3. The method of claim 2, wherein executing the power sink protocol includes executing a standby mode of the at least one mode control in response to the state of charge exceeding the state of charge threshold.

4. The method of claim 3, wherein executing the standby mode includes executing power management of a fuel cell of the fuel cell system.

5. The method of claim 4, wherein regulating the airflow includes executing the valve command including closing at least one valve to the fuel cell, the at least one valve between a compressor of the airflow system and the fuel cell.

6. The method of claim 4, wherein regulating the airflow includes executing the compressor command including sinking power on a compressor of the airflow system.

7. The method of claim 1, wherein executing the power sink protocol includes executing a run mode of the at least one mode control.

8. The method of claim 7, wherein executing the run mode includes regulating the airflow from a compressor of the airflow system via at least one of an isolation valve and a bypass valve.

9. A control system for a vehicle, the control system comprising:
data processing hardware; and
memory hardware in communication with the data processing hardware, the memory hardware storing instructions that when executed on the data processing hardware cause the data processing hardware to perform operations comprising:
receiving, at a propulsion controller, power generation;
comparing, via the propulsion controller, battery data with a state of charge threshold;
executing, based on the comparison of the battery data, a power sink protocol including at least one mode control via a fuel cell system;
generating, based on the at least one mode control, at least one of a compressor command and a valve command via an airflow system; and
regulating, via the at least one generated compressor command and the valve command, an airflow of the airflow system.

10. The control system of claim 9, wherein comparing the battery data with the state of charge threshold includes determining a state of charge of the battery data exceeds the state of charge threshold.

11. The control system of claim 10, wherein executing the power sink protocol includes executing a standby mode of the at least one mode control in response to the state of charge exceeding the state of charge threshold.

12. The control system of claim 11, wherein executing the standby mode includes executing power management of a fuel cell of the fuel cell system.

13. The control system of claim 12, wherein regulating the airflow includes executing the valve command including closing at least one valve to the fuel cell, the at least one valve between a compressor of the airflow system and the fuel cell.

14. The control system of claim 12, wherein regulating the airflow includes executing the compressor command including sinking power on a compressor of the airflow system.

15. The control system of claim 9, wherein executing the power sink protocol includes executing a run mode of the at least one mode control.

16. The control system of claim 15, wherein executing the run mode includes regulating the airflow from a compressor of the airflow system via at least one of an isolation valve and a bypass valve.

17. A control system for a vehicle, the control system comprising:
data processing hardware; and
memory hardware in communication with the data processing hardware, the memory hardware storing instructions that when executed on the data processing hardware cause the data processing hardware to perform operations comprising:
receiving, at a propulsion controller, power generation;
comparing, via the propulsion controller, battery data with a state of charge threshold;
executing, based on the comparison of the battery data, a power sink protocol including at least one mode control via a fuel cell system, the at least one mode control including a standby mode and a run mode;
selecting, via a fuel cell controller, one of the standby mode and the run mode;
generating, based on the selected at least one mode control, at least one of a compressor command and a valve command via an airflow system;
regulating, via the at least one generated compressor command and the valve command, an airflow of the airflow system;
monitoring, at the fuel cell system, fuel cell data; and
adapting, based on the monitored fuel cell data, the power sink protocol including the selected mode control.

18. The control system of claim 17, further including executing, at the fuel cell system, fuel cell diagnostics.

19. The control system of claim 17, wherein executing the power sink protocol includes executing a standby mode of the at least one mode control in response to the state of charge exceeding the state of charge threshold and executing power management of a fuel cell of the fuel cell system.

20. The control system of claim 17, wherein executing the power sink protocol includes executing a run mode of the at least one mode control and regulating the airflow from a compressor of the airflow system via an isolation valve.
